(19) United States
(12) Patent Application Publication
(10) Pub. No.: US 2013/0248556 A1
(43) Pub. Date: Sep. 26, 2013

(54) Blade assembly with liquid reservoir

(71) Applicant: Michael P. May, Wamego, KS (US)

(72) Inventor: Michael P. May, Wamego, KS (US)

(73) Assignee: CATERPILLAR INC., Peoria, IL (US)

(21) Appl. No.: 13/426,336

(22) Filed: Mar. 21, 2012

(51) Int. Cl. E02F 3/96; B60P 3/22; E02F 3/40

(52) U.S. Cl. 222/1; 37/444; 37/403

(57) ABSTRACT

A blade assembly includes a frame and an integral liquid storage tank supported by the frame. The liquid storage tank can include a fill port and at least one dispensing port. The blade assembly can be mounted to a body of a machine, such as a landfill compactor, for example. Liquid stored in the integral liquid storage tank can be dispensed therefrom while the machine moves over a surface of a worksite.

### TECHNICAL FIELD

This patent disclosure relates, generally, to a blade assembly for a machine, and, more particularly, to a blade assembly with a reservoir for liquid.

### BACKGROUND

Land disposal of solid wastes has been practiced for centuries. Landfills remain the primary solid waste disposal option for most countries. Solid waste in a landfill degrades through aerobic and anaerobic processes. The degradation products generated from the stabilization process include gas and leachate.

Landfill gas (LFG) is generated by the anaerobic biological degradation of organic material. The LFG can be used to generate electricity, fire boilers, or substitute for other energy sources, for example.

Landfill leachate is a fluid that is made of water which, after being in contact with the refuse, has “leached” chemicals from the landfill. The water—mainly from precipitation—can dissolve soluble organics and inorganics. Leachate can be handled by landfill operators as single pass leachate or recirculating leachate.

For single pass leaching, the liquid leachate stream is collected, stored in a lagoon or tank, and treated either onsite or offsite before being discharged to a receiving system. Landfill companies have to incur expenses and deploy resources to dispose of the single-pass leachate.

Under the recirculation strategy, the leachate is collected and recirculated through the landfill system by reintroducing the collected leachate into the landfill. Using leachate recirculation, a landfill operator can: increase LFG generation rate; augment energy recovery potential; increase waste settlement, leading to recoverable and ultimately more efficient use of landfill air space; and avoid leachate transport to a remote treatment facility.

A landfill bioreactor is an example of a landfill that can use recirculated leachate. A landfill operated as a bioreactor can take water from ponds, biosolids, and other outside moisture sources and operate at high moisture contents, approximately 45 percent. A landfill bioreactor can obtain rapid and enhanced degradation of the solid waste and biological stabilization of the leachate. Compared with single-pass leaching, landfill bioreactors can provide more rapid, complete, and predictable conversion of readily-degradable solid waste components, thereby enhancing the potential for landfill gas (LFG) recovery and utilization, diminishing management time, and reducing the potential for adverse health and environmental impacts.

Wetting the working face of the landfill with leachate can promote compaction, litter control, and uniform distribution of liquid throughout the waste mass. Conventionally, a landfill operator dispenses leachate from a stand-alone tank transported by a machine or from a manual sprayer. For other work operations, such as soil compaction, for example, an operator may also apply liquid to the worksite area to help facilitate the work operation.

The Japanese patent document JP 9177118A is entitled, “Blade With Storing Part of Construction Machine,” and is directed to providing a storing part at the back of a blade of a construction machine so that a space for storing components is available. A storing part is provided integrally in the central part of a blade. A cover is provided at the upper part of the storing part. The blade is fitted to the front or the rear of a running body in the lower part of the construction machine. Tools, periodic replacement components, such as oil and filters, and materials such as articles of consumption are stored in the storing part. The storing part may be provided so that it is removable from the blade.

It will be appreciated that this background description has been created by the inventor to aid the reader, and is not to be taken as an indication that any of the indicated problems were themselves appreciated in the art. While the described principles can, in some aspects and embodiments, alleviate the problems inherent in other systems, it will be appreciated that the scope of the protected innovation is defined by the attached claims, and not by the ability of any disclosed feature to solve any specific problem noted herein.

### SUMMARY

The present disclosure is directed to providing a convenient means for storing liquid, such as leachate or water, for example, and dispensing the liquid at a worksite area. In an embodiment, a blade assembly includes a frame and a liquid storage tank integrally arranged with the frame. The liquid storage tank can include a fill port and at least one dispensing port.

In other embodiments, a machine includes a machine body and a blade assembly mounted to the machine body. The blade assembly includes a frame and an integral liquid storage tank supported by the frame. The liquid storage tank includes a fill port and at least one dispensing port.

In other embodiments, a method for dispensing liquid at a worksite is described. Liquid is stored in a liquid storage tank integrally formed with a frame of a blade assembly attached to a machine. The machine is moved over the worksite. Liquid is dispensed from the liquid storage tank upon a surface of the worksite.

Further and alternative aspects and features of the disclosed principles will be appreciated from the following detailed description and the accompanying drawings. As will be appreciated, the blade assemblies, machines, and methods for dispensing liquid disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a side elevational view of an embodiment of a machine having an embodiment of a blade assembly in accordance with principles of the present disclosure.

FIG. 2 is a perspective view, from the front and the bottom, of the blade assembly of FIG. 1.

FIG. 3 is a perspective view, from the rear and bottom, of the blade assembly of FIG. 1.

FIG. 4 is a view as in FIG. 3, illustrating a valve mechanism of the blade assembly in an open position.

FIG. 5 is a rear elevational view of the blade assembly of FIG. 1.

FIG. 6 is a side perspective view of the blade assembly of FIG. 1 with a side upright removed to illustrate an interior of an integral liquid storage tank of the blade assembly.

FIG. 7 is a rear perspective view of the blade assembly of FIG. 1, with plates removed to illustrate the interior of a liquid storage tank.

FIG. 8 is a rear perspective view, partially in section, of the blade assembly of FIG. 1, with portions of a first outer segment and a middle segment of the liquid storage tank removed for illustrative purposes.

FIG. 9 is a view as in FIG. 8, but viewed from the other side of the blade assembly.

FIG. 10 is a perspective view of an embodiment of a valve mechanism suitable for use in a blade assembly constructed in accordance with principles of the present disclosure.

FIG. 11 is a flow chart illustrating steps of an embodiment of a method for dispensing liquid at a worksite according to principles of the present disclosure.

### DETAILED DESCRIPTION

Embodiments of a blade assembly, a machine, and a method for dispensing liquid at a worksite are described herein. In embodiments, a blade assembly includes an integrated liquid storage tank.

In embodiments, an integrated liquid storage tank is disposed at a rear side of a blade assembly and incorporates at least one compartment space defined by a frame of the blade assembly. In embodiments, compartment spaces in the frame are joined together to form a tank suitable for containing a liquid by connecting these compartments through a system of channels to provide fluid flow from a top portion of the tank to a bottom portion. Cover plates are added to the frame to provide a tank with a sealed interior.

In embodiments, a closed compartment space can be formed between plates disposed at a rear side of the blade assembly and a moldboard at a front side in spaced relationship to the plates in a longitudinal direction and between a first upright and a second upright in spaced relationship to each other in a transverse direction. In some embodiments, the closed compartment space fits within the outer perimeter of the other components of the blade assembly.

In embodiments, a liquid-dispensing valve mechanism can be associated with the integral liquid storage tank to selectively dispense liquid from the tank upon, for example, a worksite. The valve mechanism can be selectively movable between a closed position and an open position. When the valve mechanism is in the closed position, the valve mechanism prevents liquid flow from the liquid storage tank. When the valve mechanism is in the open position, the valve mechanism allows liquid to flow from the liquid storage tank. The valve mechanism can be biased to the closed position.

In embodiments, an integrated liquid storage tank can define fill ports at either side of the blade assembly to facilitate the ready filling of the integrated liquid storage tank. An upper portion of the liquid storage tank can define the fill ports. The liquid storage tank can be filled with any suitable liquid, such as leachate (e.g., for leachate re-circulating at a landfill) or water (e.g., for soil compacting at construction sites).

The liquid storage tank can be configured such that liquid poured into the liquid storage tank using one of the fill ports disposed at an upper portion of the liquid storage tank can flow to a lower portion of the storage tank through the effects of gravity. The lower portion can define at least one dispensing port adapted to dispense liquid stored in the liquid storage tank.

In embodiments, each fill port of the liquid storage tank can be selectively occluded using a suitable device, such as a threaded plug, for example. In the event of a machine rollover, liquid stored in the integral liquid storage tank would not pour from the overturned liquid storage tank.

In embodiments, a blade assembly can include an integrated liquid storage tank configured such that, when the blade assembly is mounted to a machine, the integrated liquid storage tank does not extend beyond an outer perimeter of the blade assembly to maintain the visibility of an operator in a cab of the machine. The integrated liquid storage tank can also be configured to avoid interfering with blade use. The distance between the back of the blade assembly and the front of the machine can be maintained to provide a predetermined minimum clearance distance to allow a wide range of uses of the blade assembly.

In embodiments, a blade assembly includes an integral liquid storage tank that does not have to be disassembled from the blade assembly for differentiated applications. In use, the blade assembly can be used as a blade alone, as a liquid-dispensing system alone, or as both a blade and a liquid-dispensing system simultaneously.

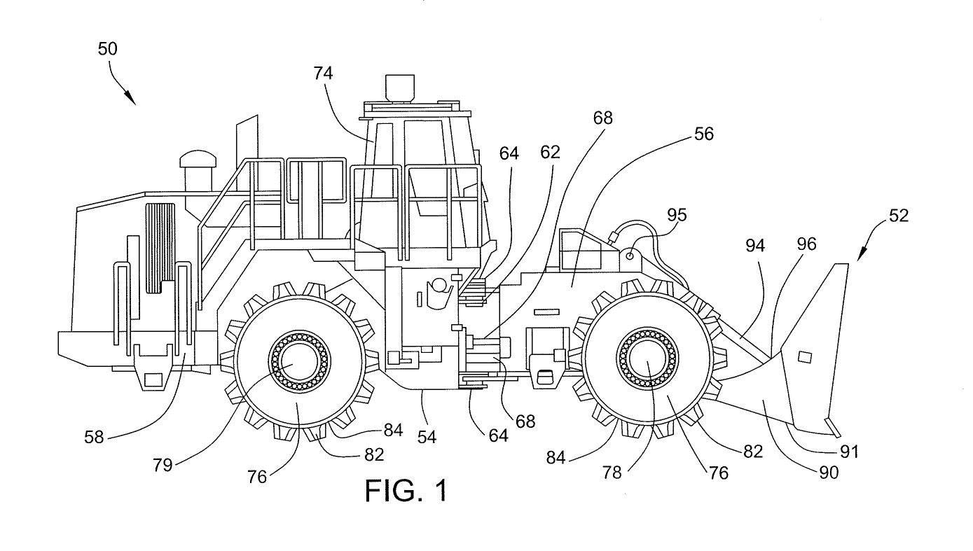

Referring now to the drawings, an exemplary embodiment of a machine 50 in the form of a landfill compactor including an embodiment of a blade assembly 52 constructed in accordance with principles of the present disclosure is illustrated in FIG. 1. It should be understood that, in other embodiments, many other types of machines, such as, road graders, wheel loaders, skid steer loaders, and the like, can include a blade assembly constructed in accordance with principles of the present disclosure. Examples of other such machines include machines used for compaction, mining, construction, farming, transportation, etc.

The machine 50 includes a body 54 having a front portion or non-engine end 56 and a rear portion or engine end 58. The non-engine end 56 and the engine end 58 of the body 54 are pivotally connected to each other at a hitch or articulation joint arrangement 62 by way of a pair of hinge joints 64. A pair of steering cylinders 68 can be mounted between the non-engine end 56 and the engine end 58 of the body 54 to provide steering.

The engine end 58 of the body 54 can support an operator station or cab 74. The engine end 58 can also support, for example, a power source and cooling system components (not shown). The power source can be operatively connected through a drive train (not shown) to drive at least one ground-engaging device (e.g., wheels, tracks, etc.) for movement of the machine 50. In the illustrated embodiment, ground-engaging devices in the form of wheels 76 are supported by a front axle 78 and a rear axle 79, which in turn are supported by the non-engine end 56 and the engine end 58, respectively. The front axle 78 and the rear axle 79 are connected to the body 54 using any suitable technique as will be understood by one skilled in the art.

In the illustrated embodiment, each wheel 76 includes a plurality of teeth 82 positioned on an outer surface 84 of the wheel 76. The teeth 82 of a particular wheel 76 can be in predetermined, spaced relationship to each other in a specific pattern across the outer surface 84 of the wheel 76 in a well-known manner to provide sufficient compacting force to the ground or debris beneath each wheel 76.

The blade assembly 52 is connected to the front portion 56 of the body 54. The blade assembly 52 is pivotally mounted to the front portion 56 of the body 54 by a first push arm 90 and a second push arm 91. A lift cylinder 94 is pivotally connected at a proximal end 95 to the front portion 56 of the body 54 and at a distal end 96 to the blade assembly 52. The lift cylinder 94 can be operated to selectively raise and lower the blade assembly 52. The lift cylinder 94 can be operated such that the blade assembly 52 is movable over a range of travel between a raised position and a lowered position.

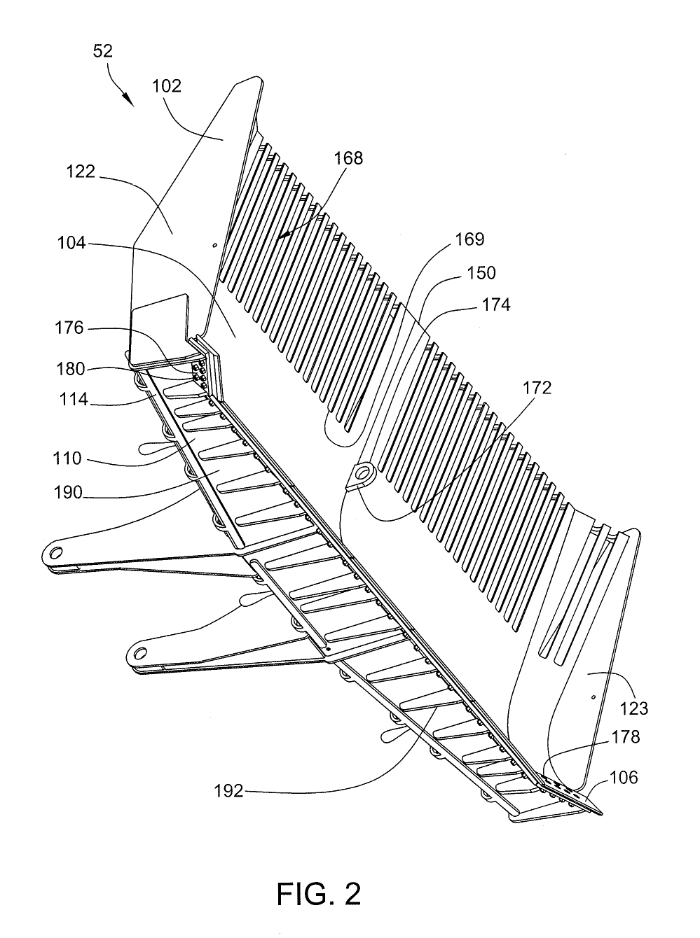

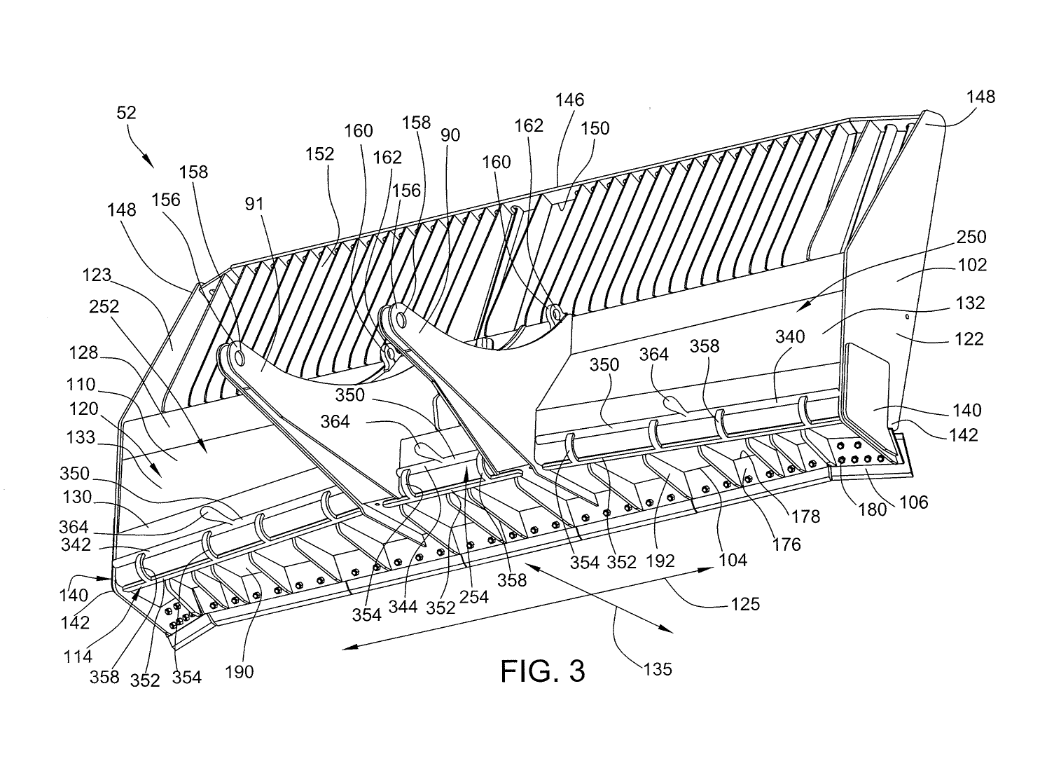

Referring to FIG. 2, the blade assembly 52 includes a frame 102, a moldboard 104 attached to the frame 102, a cutting edge blade 106 attached to the moldboard 104, a liquid storage tank 110 integrally arranged with and supported by the frame 102, and a valve mechanism 114 adapted to selectively dispense liquid stored in the liquid storage tank 110. The liquid storage tank 110 is integrated into a space defined by the frame 102 and the moldboard 104 at a rear side 120 (FIG. 3) of the blade assembly 52. The liquid storage tank 110 can be configured such that the liquid storage tank 110 is in non-interfering relationship with the body 54 of the machine 50 when the blade assembly 52 is moved over the range of travel between the lowered position and the raised position. The valve mechanism 114 can be operated to selectively dispense liquid stored in the tank 110 upon a surface of a worksite.

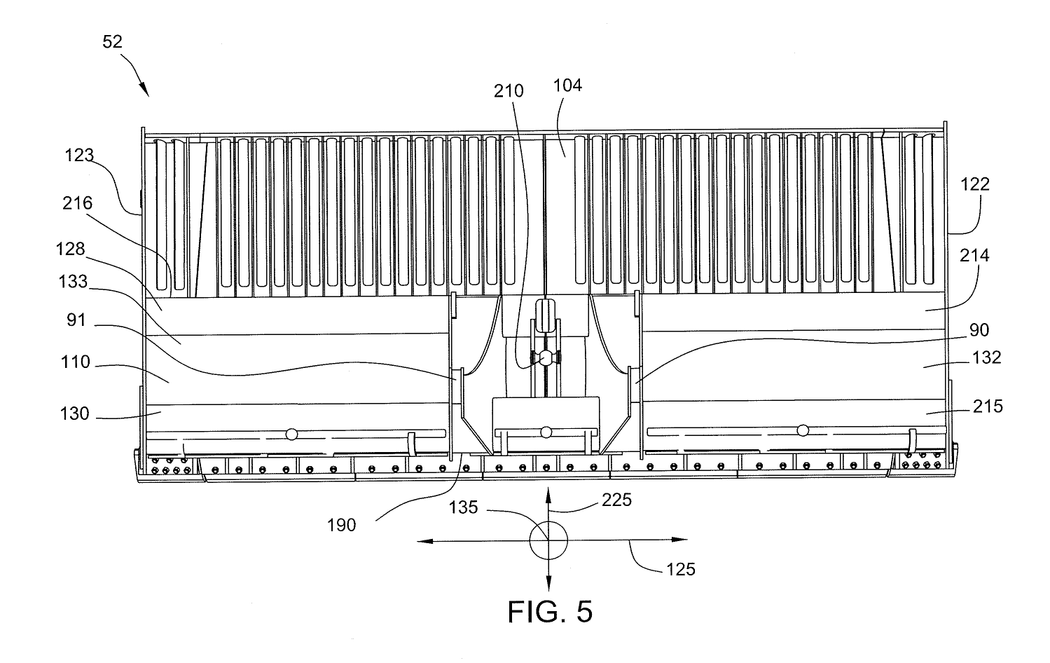

Referring to FIG. 3, the frame 102 includes the first and second push arms 90, 91, a first side upright 122 and a second side upright 123, the side uprights 122, 123 disposed in spaced relationship to each other along a transverse axis 125 (see, e.g., FIGS. 3 and 5), and an intermediate transverse support 128 and a lower transverse support 130 both extending along the transverse axis 125 between the first and second side uprights 122, 123. A first cover plate 132 extends along the transverse axis 125 between the first side upright 122 and the first push arm 90, and a second cover plate 133 extends along the transverse axis 125 between the second side upright 123 and the second push arm 91. Each illustrated cover plate 132, 133 is a substantially planar sheet of material that is configured to cover an open area defined between the intermediate transverse support 128 and the lower transverse support 130. The cover plates 132, 133 are disposed between the intermediate transverse support 128 and the lower transverse support 130 to help define the liquid storage tank 110. The cover plates 132, 133 are in spaced relationship to the moldboard 104 with respect to a longitudinal axis 135, which is perpendicular to the transverse axis 125. The cover plates 132, 133 can help provide a sealed interior for the liquid storage tank 110 suitable for storing liquid therein.

A wear plate 140 can be attached to a bottom end 142 of each side upright 122, 123. The wear plates 140 can be adapted to provide additional protection against wearing that occurs through use of the blade assembly 52 during typical blade applications, such as bulldozing, for example.

The frame 102 includes a top plate 146 extending between the side uprights 122, 123. The top plate 146 is connected to a top end 148 of each side upright 122, 123 and a top end 150 of the moldboard 104. A plurality of moldboard support gussets 152 extend vertically between the intermediate transverse support 128 and the top plate 146. The moldboard support gussets 152 can help provide rigidity to the moldboard 104.

The push arms 90, 91 extend from the rear side 120 of the blade assembly 52 from the intermediate transverse support 128 and the lower transverse support 130. Each push arm 90, 91 includes a distal end 156 defining a machine mounting hole 158 adapted to receive a connecting element therethrough to pivotally mount the blade assembly 52 to the body 54 of the machine 50. A suitable fastening element can include a pin, for example. In other embodiments, the distal end 156 of each push arm 90, 91 can include another mechanism adapted to pivotally connect the blade assembly 52 to the machine 50, e.g., a trunnion or a component of a ball and socket connection.

Each push arm 90, 91 includes a handling tab 160 disposed adjacent the intermediate transverse support. Each handling tab 160 defines a hole 162 that is adapted to receive a coupling element therethrough, such as a hook or other coupling element, for example. A suitable chain or rope can be secured to the hooks at one end and to a suitable lifting machine at the other end. The lifting machine can lift the blade assembly 52 via the connection through the handling tabs 160 to facilitate the transport of the blade assembly 52 to a desired location.

Referring to FIG. 2, the moldboard 104 extends between the first and second side uprights 122, 123. The moldboard 104 can include a rack portion 168 disposed at the top end 150 thereof. The rack portion 168 defines a series of vertically extending slots 169. The slots 169 can be configured to improve operator visibility from the operator station or cab 74 of the machine 50. An operator in the operator station 74 can look through the slots 169 defined by the rack portion 168 of the moldboard 104 to increase the range of visible area in front of the machine 50 available to the operator. The moldboard 104 can include a towing tab 172 extending therefrom. The towing tab 172 can define a hole 174 suitable for receiving a connecting element therethrough to allow the blade assembly 52 to be used for a towing operation, for example.

Referring to FIGS. 2 and 3, a base edge 176 can be welded to a bottom end 178 of the moldboard 104. The cutting edge blade 106 can be secured to the base edge 176 via a plurality of bolts 180. In use, the cutting edge blade 106 can be replaced from time to time for maintenance or for replacement.

The lower transverse support 130 includes a bottom backup plate 190 that extends to the moldboard 104. The bottom backup plate 190 is disposed adjacent the base edge 176 of the moldboard 104. The bottom backup plate 190 defines a bottom of the integral liquid storage tank 110.

A plurality of base edge support gussets 192 can be provided to increase the rigidity of the base edge 176 of the moldboard 104. The base edge support gussets 192 can be welded to the base edge 176 and to the bottom backup plate 190. In other embodiments, other suitable connection techniques can be used.

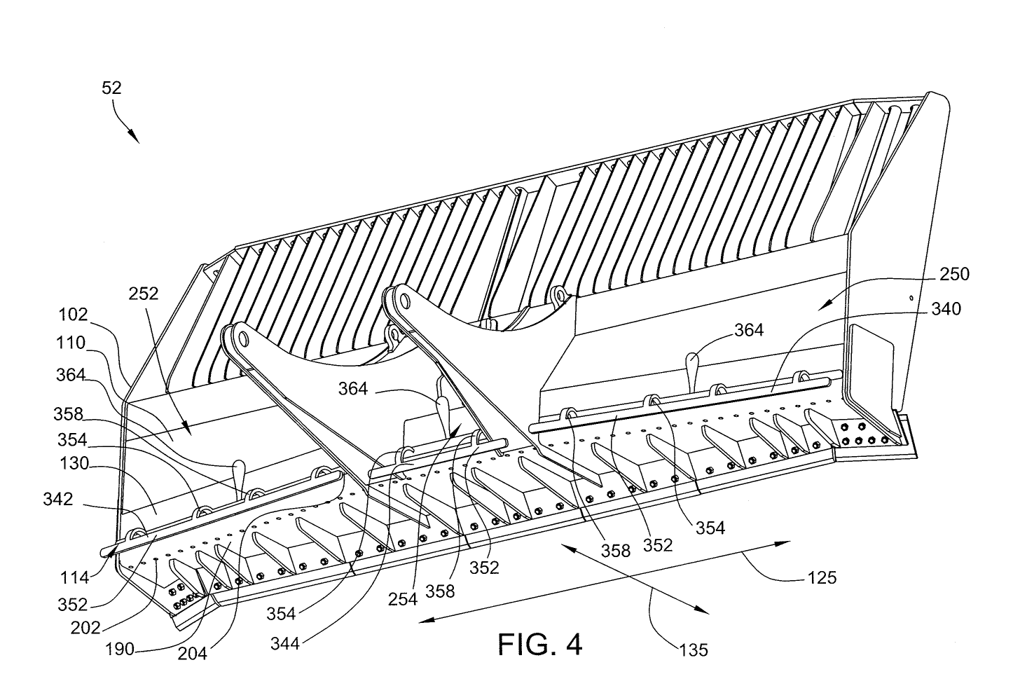

Referring to FIGS. 3 and 4, the liquid storage tank 110 of the blade assembly 52 extends along the transverse axis 125 and includes a plurality of dispensing ports 202 in spaced relationship to each other along the transverse axis 125. The bottom backup plate 190 of the lower transverse support 130 of the frame 102 defines the dispensing ports 202 of the liquid storage tank 110. The dispensing ports 202 are disposed adjacent a rear edge 204 of the bottom backup plate 190.

The valve mechanism 114 is adapted to selectively dispense liquid stored in the liquid storage tank 110 from at least one of the dispensing ports 202. The valve mechanism 114 can control the flow of liquid from the liquid storage tank 110 through the dispensing ports 202. The valve mechanism 114 can be suitably supported by the frame 102. To selectively dispense liquid stored in the liquid storage tank 110, the valve mechanism 114 can be moved over a range of travel from a closed position (FIG. 3) in which the valve mechanism 114 sealingly occludes the dispensing ports 202 and an open position (FIG. 4) in which the valve mechanism 114 is in displaced relationship with the dispensing ports 202 to allow liquid stored in the tank 110 to flow from the tank 110 through the dispensing ports 202. The valve mechanism 114 can be arranged with each dispensing port 202 associated with the liquid storage tank 110 and can be adapted to selectively dispense liquid stored in the liquid storage tank 110 from the dispensing ports 202.

Referring to FIG. 5, the blade assembly 52 can include a lift cylinder trunnion 210 that is adapted for pivotal connection to the lift cylinder 94 of the machine 50. The proximal end 94 of the lift cylinder 94 can be connected to the front portion 56 of the body 54 of the machine 50, and the distal end 96 of the lift cylinder 94 can be connected to the lift cylinder trunnion 210 of the blade assembly 52 to facilitate the selective raising and lowering of the blade assembly 52 in operation. The lift cylinder trunnion 210 is disposed between the push arms 90, 91. In other embodiments, a different connecting mechanism for pivotally connecting the blade assembly 52 to the lift cylinder 94 can be provided.

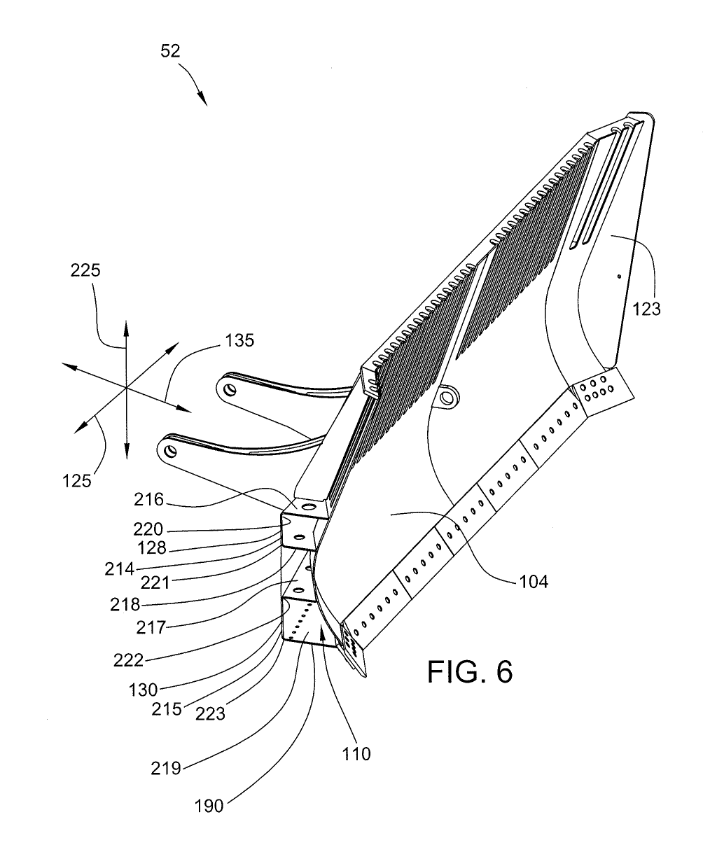

Referring to FIG. 6, the intermediate transverse support 128 and the lower transverse support 130 of the blade assembly 52 both have a substantially U-shaped cross section. The intermediate transverse support 128 and the lower transverse support 130 both include a backup plate 214, 215 and a top flange 216, 217 and a bottom flange 218, 219 extending from a respective end 220, 221, 222, 223 of each backup plate 214, 215 to define the U-shaped cross-section. The bottom flange 219 of the lower transverse support 130 comprises the bottom backup plate 190 in the illustrated embodiment.

Referring to FIGS. 5 and 6, the liquid storage tank 110 is defined by the intermediate transverse support 128, the first and second cover plates 132, 133, the lower transverse support 130, and the moldboard 104. The liquid storage tank 110 extends between and includes the intermediate transverse support 128 and the lower transverse support 130. In the illustrated embodiment, the liquid storage tank 110 extends between the first and second side uprights 122, 123 along the transverse axis 125, between the bottom backup plate 190 and the top flange 216 of the intermediate transverse support 128 along a vertical axis 225 (perpendicular to both the transverse axis 125 and the longitudinal axis 135), and between the moldboard 104 and the backup plates 214, 215 of the intermediate transverse support 128 and the lower transverse support 130 and the first and second cover plates 132, 133 along the longitudinal axis 135. In some embodiments, the liquid storage tank 110 is integrally arranged entirely within the frame and does not extend beyond an outer perimeter of the frame.

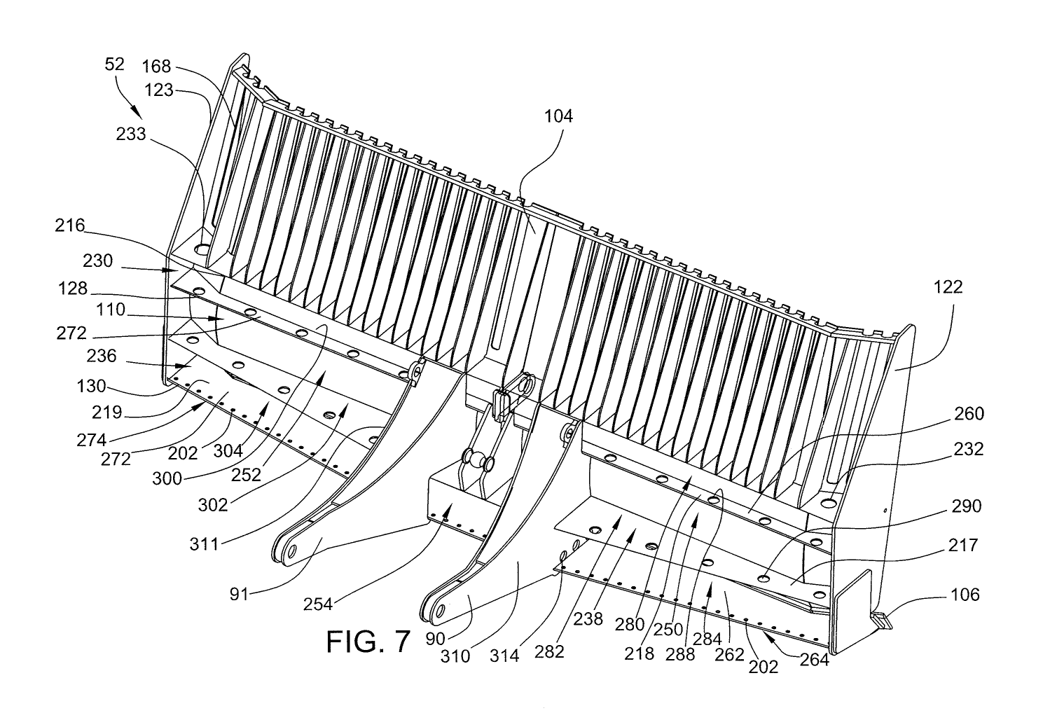

Referring to FIG. 7, the liquid storage tank 110 of the blade assembly 52 is substantially U-shaped. The liquid storage tank 110 includes an upper portion 230 comprising the intermediate transverse support 128 that defines a first fill port 232 and a second fill port 233. The first and second fill ports 232, 233 are respectively disposed adjacent the first and second side uprights 122, 123. The top flange 216 of the intermediate transverse support 128 defines the fill ports 232, 233. The liquid storage tank 110 includes a lower portion 236 that defines the dispensing ports 202. The bottom flange 219 of the lower transverse support 130 defines the dispensing ports 202. The upper portion 230 and the lower portion 236 can be configured such that liquid entering the liquid storage tank 110 through one of the fill ports 232, 233 flows from the fill port 232, 233 into the liquid storage tank 110 to the dispensing ports 202 in the lower portion 236.

The fill ports 232, 233 can be each adapted to be selectively occluded such that liquid in the liquid storage tank 110 is prevented from being dispensed from the liquid storage tank 110 through the fill ports 232, 233 even in the event of the machine 50 undergoes a rollover. In some embodiments, each fill port 232, 233 can be equipped with a removable threaded plug that threadedly engages the fill port 232, 233 with which it is engaged. In other embodiments, a quick-type fill device such as a spring-loaded flap which opens inwardly can be provided to act as the cover for each fill port 232, 233. The inward-opening flap can allow a user to readily fill the liquid storage tank 110 by, for example, inserting a fill hose into the liquid storage tank 110 by pushing the inward-opening flap into the liquid storage tank 110 to allow the fill hose to be inserted into the liquid storage tank through one of the fill ports 232, 233 without having to remove a threaded plug. The inward-opening flap can also prevent liquid from unintentionally flowing from the liquid storage tank 110 by way of the fill ports 232, 233, even in situations where the machine 50 undergoes a rollover.

In the illustrated embodiment, the upper portion 230 of the liquid storage tank 110 is adjacent the rack portion 168 of the moldboard 104, and the lower portion 236 of the liquid storage tank 110 is adjacent the cutting edge blade 106. In some embodiments, the liquid storage tank 110 can include an interior surface 238 having a corrosion-resistant coating.

In the illustrated embodiment, the liquid storage tank 110 includes a first outer segment 250, a second outer segment 252, and a middle segment 254 disposed between the first and second outer segments 250, 252. Each outer segment 250, 252 is disposed in outward lateral relationship to one of the push arms 90, 91. The middle segment 254 is disposed between the first and second outer segments 250, 252. Each outer segment 250, 252 of the liquid storage tank 110 includes one of the fill ports 232, 233. In some embodiments, a fill port can be provided in the middle segment 254.

The first outer segment 250 of the liquid storage tank 110 is defined by the first side upright 122, the moldboard 104, a first portion 260 of the intermediate transverse support 128 defining the first fill port 232, the first cover plate 132 (FIG. 5), a first portion 262 of the lower transverse support 130 defining a first series 264 of the dispensing ports 202, and the first push arm 90. The second outer segment 252 of the liquid storage tank is defined by the second side upright 123, the moldboard 104, a second portion 270 of the intermediate transverse support 128 defining the second fill port 233, the second cover plate 133 (FIG. 5), a second portion 272 of the lower transverse support 130 defining a second series 274 of the dispensing ports 202, and the second push arm 91.

The first and second outer segments 250, 252 are substantially mirror images of each other. Accordingly, it should be understood that the description of one of the outer segments 250, 252 is applicable to the other, as well.

In the first outer segment 250 of the liquid storage tank 110, the first portion 260 of the intermediate transverse support 128, the moldboard 104, the first side upright 122, and the first push arm 90 define an upper compartment 280. The bottom flange 218 of the intermediate transverse support 128, the first cover plate 132, the top flange 217 of the lower transverse support 130, the moldboard 104, the first side upright 122, and the first push arm 90 define an intermediate compartment 282. The first portion 262 of the lower transverse support 130, the moldboard 104, the first side upright 122, and the first push arm 90 define a first outer lower compartment 284.

The bottom flange 218 of the intermediate transverse support 128 includes a plurality of upper transfer holes 288 in communication with the upper compartment 280 and the intermediate compartment 282. The upper transfer holes 288 are adapted to allow fluid to flow between the upper compartment 280 and the intermediate compartment 282 of the first outer segment 250 of the liquid storage tank 110. For example, the upper transfer holes 288 allow liquid entering the upper compartment 280 of the first outer segment 250 of the liquid storage tank 110 through the first fill port 232 to flow through the upper compartment 280 into the intermediate compartment 282.

The top flange 217 of the lower transverse support 130 includes a plurality of lower transfer holes 290 in communication with the intermediate compartment 282 and the first outer lower compartment 284. The lower transfer holes 290 are adapted to allow fluid to flow between the intermediate compartment 282 and the first outer lower compartment 284 of the first outer segment 250 of the liquid storage tank 110. For example, the lower transfer holes 290 are adapted to allow fluid in the intermediate compartment 282 to flow from the intermediate compartment 282 to the first outer lower compartment 284.

The second outer segment 252 of the liquid storage tank 110 is a mirror image of the first outer segment 250. The second outer segment 252 includes an upper compartment 300, an intermediate compartment 302, and a second outer lower compartment 304.

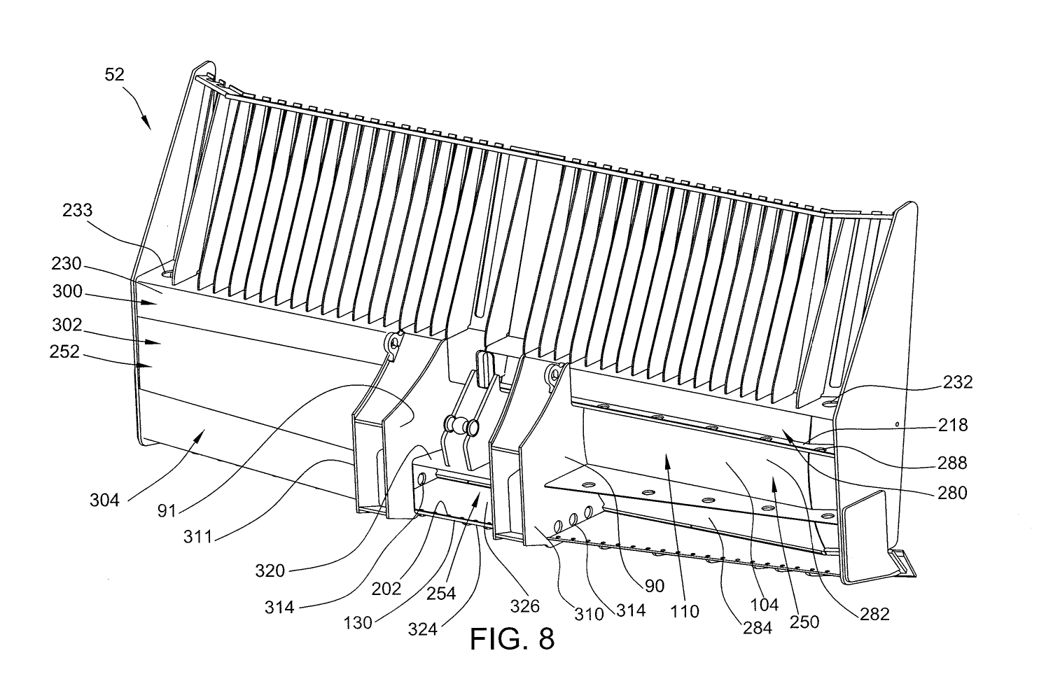

Referring to FIGS. 7 and 8, the first and second push arms 90, 91 each includes an outer sidewall 310, 311 that defines a plurality of middle transfer holes 314 in communication with the middle segment 254 of the liquid storage tank 110 and with, respectively, the first and second outer lower compartments 284, 304 of the first and second outer segments 250, 252. The middle transfer holes 314 are adapted to allow fluid in the first and second outer lower compartments 284, 304 to flow from the first and second outer segments 250, 252 to the middle segment 254 of the liquid storage tank 110. In addition, liquid can flow from the middle segment 254 of the liquid storage tank 110 to one or both of the outer segments 250, 252 of the liquid storage tank 110, by influence of gravity, for example, to allow liquid in the liquid storage tank 110 to achieve a self-balancing level across the first and second outer segments 250, 252 and the middle segment 254 of the liquid storage tank 110.

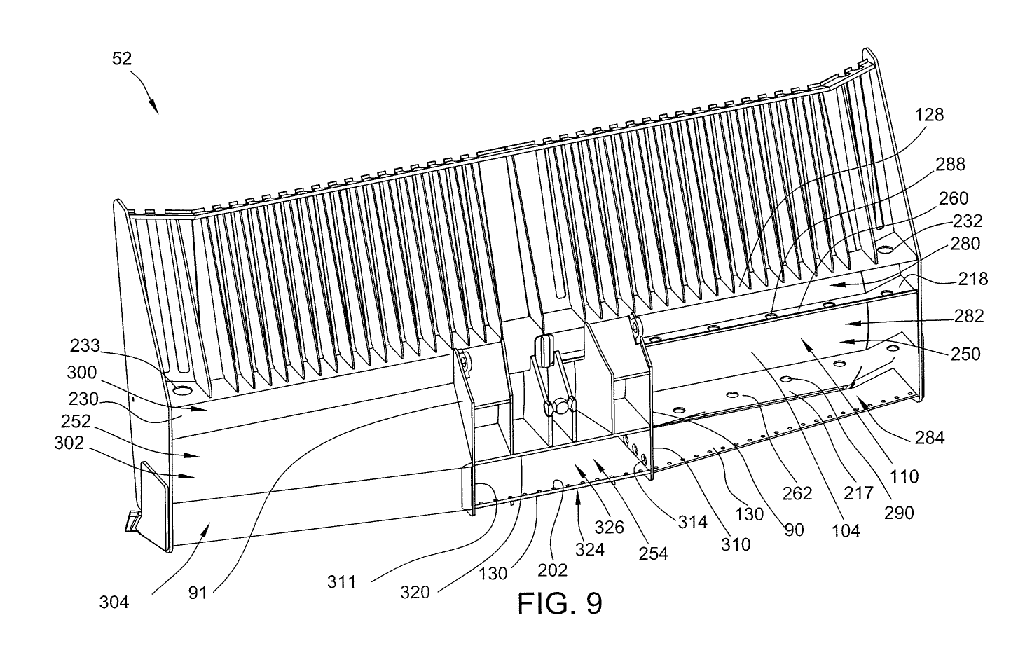

Referring to FIGS. 8 and 9, the middle segment 254 of the liquid storage tank 110 of the blade assembly 52 is defined by a middle portion 320 of the lower transverse support 130, the outer sidewalls 310, 311 of the push arms 90, 91, and the moldboard 104. The middle portion 320 of the lower transverse support 130 defines a middle series 324 of the dispensing ports. The middle segment 254 of the liquid storage tank 110 defines a middle compartment 326. Liquid in the middle compartment 326 can selectively flow, via operation of the valve mechanism 114, from the middle series 324 of the dispensing ports 202 in communication with the middle compartment 326. Liquid in the middle compartment 326 can also flow to one or both of the outer lower compartments 284, 304, under the influence of gravity, for example, to allow the liquid in the storage tank 110 to obtain a self-balancing level across the first and second outer segments 250, 252 and the middle segment 254 of the liquid storage tank 110.

In some embodiments, the compartments 280, 282, 284, 300, 302, 304, 326 of the liquid storage tank 110 can have a coating applied to its interior to enhance the corrosion resistance of the storage tank 110. In other embodiments, other corrosion resistance measures can be taken.

In use, the liquid can flow from one of the upper compartments 280, 300 to the associated outer lower compartments 284, 304. Liquid can be selectively dispensed from the dispensing ports 202 across the lower compartments 284, 304 and the middle compartment 326 of the liquid storage tank 110. The valve mechanism 114 can control the flow of liquid from the liquid storage tank 110 through the dispensing ports 202.

A user can fill the liquid storage tank 110 by pouring liquid through one of the fill ports 232, 233 in the upper portion 230 of the liquid storage tank 110. For example, liquid entering the liquid storage tank 110 through the first fill port 232 enters the upper compartment 280 of the first outer segment 250.

Referring to FIG. 9, liquid in the upper compartment 280 flows through the upper transfer holes 288 in the bottom flange 218 of the first portion 260 of the intermediate transverse support 128 and enters the intermediate compartment 282 disposed below the upper compartment 280 receiving liquid through the first fill port 232. Liquid in the intermediate compartment 282 can flow through the lower transfer holes 290 disposed in the top flange 217 of the first portion 262 of the lower transverse support 130, thereby entering the first outer lower compartment 284 of the first outer segment 250 of the liquid storage tank 110.

Liquid in the first outer lower compartment 284 can also flow through the middle transfer holes 314 disposed in the first push arm 90 into the middle segment 254 of the liquid storage tank 110. The liquid can continue to flow from the middle segment 254 to the second outer lower compartment 304 of the second outer segment 252 of the liquid storage tank 110. Liquid can flow between the first and second outer lower compartments 284, 304 and the middle compartment 326 so that the liquid in the storage tank 110 can achieve a self-balancing level. When the first and second outer lower compartments 284, 304 and the middle compartment 326 are completely filled with liquid, the self-balancing action of the liquid continues in the intermediate compartments 282, 302 of the first and second outer segments 250, 252 of the liquid storage tank 110. Further, when the intermediate compartments 282, 302 of the first and second outer segments 250, 252 are completely filled with liquid, the self-balancing action of the liquid continues in the upper compartments 280, 300 of the first and second outer segments 250, 252 of the liquid storage tank 110.

Referring to FIGS. 3 and 4, to selectively dispense liquid stored in the liquid storage tank 110, the valve mechanism 114 can be provided. The valve mechanism 114 can be arranged with each dispensing port 202 associated with the liquid storage tank 110 and can be adapted to selectively dispense liquid stored in the liquid storage tank 110 from the dispensing ports 202. The valve mechanism 114 can be movable over a range of travel between a closed position (FIG. 3), wherein the valve mechanism 114 is in occluding relationship with the dispensing ports 202 such that liquid in the liquid storage tank 110 is prevented from being dispensed from the dispensing ports 202, and an open position (FIG. 4), wherein the valve mechanism 114 is disengaged from the dispensing ports 202 such that liquid in the liquid storage tank 110 is allowed to flow from the liquid storage tank 110 through the dispensing ports 202.

In embodiments, the valve mechanism 114 can include a plurality of valve segments 340, 342, 344 corresponding to the outer segments 250, 252 and the middle segment 254 of the liquid storage tank 110. Each valve segment 340, 342, 344 can include a spring-loaded torsion bar 350 and a seal member 352 connected together by a framework 354. The framework 354 can include a series of curved connecting arms 358 in spaced relationship to each other axially along the torsion bar 350.

The torsion bar 350 and the seal member 352 are pivotally connected together via the framework 354 such that the seal member 352 is movable over a range of travel between a sealed position (FIG. 3), wherein the seal member 352 is in occluding relationship with the dispensing ports 202 such that liquid in the liquid storage tank 110 is prevented from being dispensed from the dispensing ports 202, and a disengaged position (FIG. 4), wherein the seal member 352 is displaced from the dispensing ports 202 such that liquid in the liquid storage tank 110 is allowed to flow from the liquid storage tank 110 through the dispensing ports 202. The torsion bar 350 can be biased to urge the seal member 352 to the sealed position.

In embodiments, each valve segment 340, 342, 344 can include a trigger mechanism 364 that is arranged with the torsion bar 350. The trigger mechanism 364 can be operated to selectively move the seal member 352 from the sealed position to the disengaged position. In the illustrated embodiment, the trigger mechanism 364 is in the form of a handle.

In some embodiments, each valve segment 340, 342, 344 can be independently operated by the associated trigger mechanism 364 to selectively dispense liquid stored in the liquid storage tank 110 from the dispensing ports 202 occluded by the respective valve segment 340, 342, 344 associated with the operated trigger mechanism 364.

In other embodiments, the trigger mechanisms of various valve segments can be tied together such that operating one trigger mechanism operates the other trigger mechanisms so that the entire valve mechanism is in the open position. In still other embodiments, a trigger mechanism can be provided that is adapted to selectively operate multiple valve segments.

The valve mechanism 114 can be arranged with the dispensing ports 202 and adapted to selectively dispense liquid stored in the liquid storage tank 110 from the dispensing ports 202. Referring to FIG. 3, the valve mechanism 114 is shown in the closed position. The seal member 352 of each valve segment 340, 342, 344 is in the sealed position and sealingly occludes the dispensing ports 202 to which it is associated. Referring to FIG. 4, the valve mechanism 114 is shown in the open position. The seal member 352 of each valve segment 340, 342, 344 is displaced from the associated dispensing ports 202 of the liquid storage tank 110 to allow liquid stored in the liquid storage tank 110 to flow therefrom.

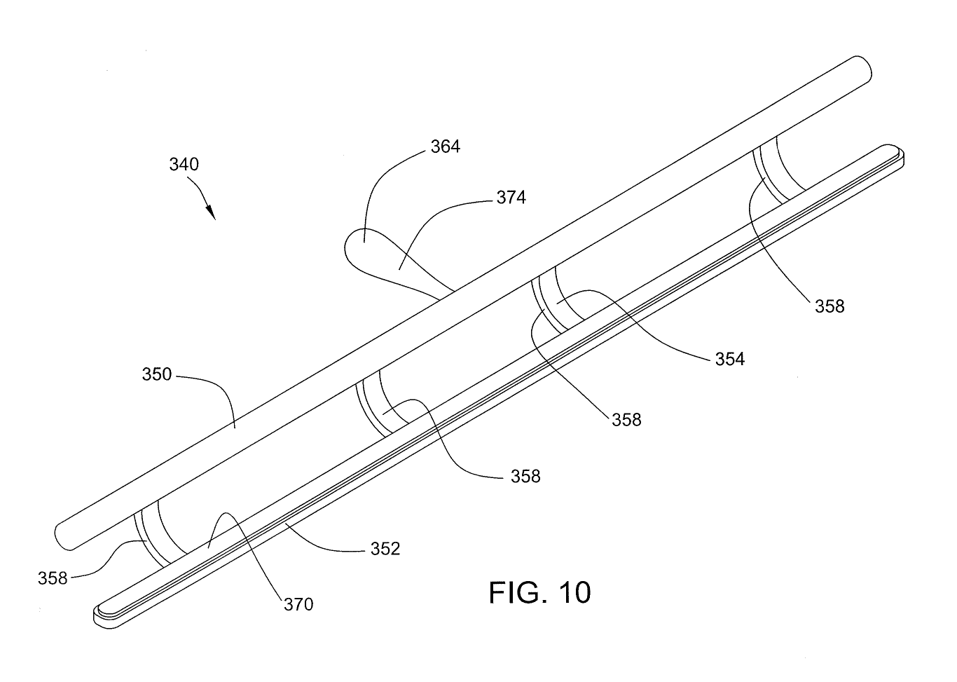

Referring to FIG. 10, a representative valve segment 340 of the valve mechanism 114 is shown. In embodiments, the valve mechanism 114 can include a suitable number of valve segments 340, 342, 344 to selectively occlude the dispensing ports 202 provided in the liquid storage tank 110. Each seal member 352 of the valve segments 340, 342, 344 can include a sealing element 370 made from a material suitable for sealing the dispensing ports 202 to sufficiently prevent the flow of liquid from the tank 110 as desired for the intended application.

In the illustrated embodiment, the sealing element 370 comprises a neoprene pad. In other embodiments, other suitable materials can be used for the sealing element 370.

The valve segment 340 can be biased to a sealed position in which the sealing element 370 sealingly occludes the dispensing ports 202 over which the seal member 352 is disposed. A biasing mechanism in the form of the torsion bar 350, for example, can force the neoprene sealing element 370 against the dispensing ports 202 in the bottom of the liquid storage tank 110 to prevent liquid in the liquid storage tank 110 from flowing out of the tank 110 through the dispensing ports 202 while the valve segment 340 is in the sealed position.

The torsion bar 350 provides rotational force to the connecting arms 358 of the framework 354 to urge the seal member 352 against the dispensing ports 202 disposed at the bottom of the liquid storage tank 110 to prevent liquid flow from the tank 110. An external force can be applied to the torsion bar 350 to overcome the biasing force it creates which urges the torsion bar 350 to the sealed position to rotate the seal member 352 from the sealed position to the disengaged position.

The trigger mechanism 364 can be provided to selectively rotate the valve segment 340 against the biasing rotational force of the torsion bar 350 to separate the neoprene sealing element 370 from the dispensing ports 202 at the bottom of the liquid storage tank 110 to release liquid from the storage tank 110. In the illustrated valve segment 340, a handle 374 is mounted to the torsion bar 350 to facilitate the movement of the torsion bar 350 from the sealed position to the released position. The illustrated handle 374 can be provided to facilitate the application of external force to the torsion bar 350.

In embodiments, a latch mechanism (not shown) can be provided that is selectively engageable with the handle 374 to retain the handle 374 in place when the torsion bar 350 is acted upon to move the seal member 352 to the disengaged position. The handle 374 and the latch can be operated manually to open the dispensing ports 202 at the bottom of the tank 110.

In other embodiments, the valve segment 340 can be provided with a trigger mechanism 364 that is adapted to be triggered so that the torsion bar 350 moves the seal member 352 from the sealed position to the disengaged position by lowering the blade assembly 52 to the point where the trigger mechanism 364 contacts an external object (e.g., a handle can be triggered by coming into contacting engagement with the ground or a part of the body 54 of the machine 50). In other embodiments, the trigger mechanism 364 can be in the form of an electric step motor adapted to be operated remotely to rotate the seal member 352 about the torsion bar 350. In still other embodiments, the trigger mechanism 364 can be in the form of a hydraulically-activated actuator or valve provided within the torsion bar 350 and adapted to selectively rotate the framework 354.

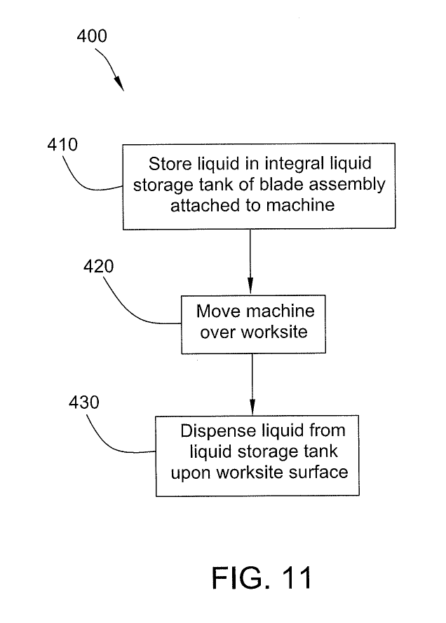

Referring to FIG. 11, an embodiment of a method 400 for dispensing liquid upon a surface of a worksite can be performed using an embodiment of a blade assembly constructed in accordance with principles of the present disclosure. Liquid can be stored in an integral liquid storage tank supported by a frame of a blade assembly attached to a machine (step 410). Liquid can be stored in the liquid storage tank by filling the liquid storage tank with a liquid poured through a fill port communicating with the interior of the liquid storage tank. The machine can be moved over the worksite (step 420). Liquid can be dispensed from the liquid storage tank upon a surface of the worksite (step 430). Liquid can be selectively dispensed from the liquid storage tank upon the surface of the worksite by operating a valve mechanism arranged with at least one dispensing port communicating with the interior of the liquid storage tank. Any suitable liquid can be used, e.g., leachate or water. The worksite can be any suitable environment.

### INDUSTRIAL APPLICABILITY

The industrial applicability of embodiments of a blade assembly constructed according to principles of the present disclosure will be readily appreciated from the foregoing discussion. The described principles are applicable to various machines and equipment and have applicability in many machines which use dozer blades.

For example, in some embodiments, a worksite can comprise a landfill. Leachate can be collected from the landfill and poured into an integral liquid storage tank 110 of a blade assembly 52 constructed in accordance with principles of the present disclosure. The leachate can be re-circulated to the landfill by reintroducing the collected leachate into the landfill. A machine 50 to which the blade assembly 52 is mounted can traverse a surface of the landfill and dispense the collected leachate from the liquid storage tank 110 of the blade assembly 52. The surface of the landfill can be wetted with leachate to promote compaction, litter control, and uniform distribution of liquid throughout the waste mass of the landfill.

In another embodiment, an integral liquid storage tank 110 of a blade assembly 52 constructed in accordance with principles of the present disclosure can be mounted to a machine 50. The liquid storage tank 110 can be filled with water. The machine 50 can be driven over a worksite that includes an area of soil selected for compaction. The machine 50 can traverse the worksite area. Water can be dispensed from the liquid storage tank 110 of the blade assembly 52 upon the worksite area to promote the compaction of the soil.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for the features of interest, but not to exclude such from the scope of the disclosure entirely unless otherwise specifically indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

What is claimed is:

1. A blade assembly comprising:
a frame;
a liquid storage tank integrally arranged with the frame, the liquid storage tank including a fill port and at least one dispensing port.

2. The blade assembly of claim 1, wherein the frame includes a pair of side uprights, an intermediate transverse support and a lower transverse support, the intermediate transverse support and the lower transverse support extending between the side uprights, the liquid storage tank extending between and including the intermediate transverse support and the lower transverse support.

3. The blade assembly of claim 2, wherein the liquid storage tank includes an upper portion defining a pair of fill ports, the fill ports respectively disposed adjacent the side uprights.

4. The blade assembly of claim 1, wherein the liquid storage tank extends along a transverse axis and includes a plurality of dispensing ports in spaced relationship along the transverse axis, the liquid storage tank including an upper portion and a lower portion, the upper portion defining the fill port, and the lower portion defining the dispensing ports.

5. The blade assembly of claim 1, further comprising:
a valve mechanism, the valve mechanism adapted to selectively dispense liquid stored in the liquid storage tank from at least one dispensing port.

6. The blade assembly of claim 5, wherein the liquid storage tank extends along a transverse axis and includes a plurality of dispensing ports in spaced relationship along the transverse axis, the liquid storage tank including an upper portion and a lower portion, the upper portion defining the fill port, and the lower portion defining the dispensing ports.

7. The blade assembly of claim 6, wherein the valve mechanism includes a torsion bar having a sealing member, the torsion bar pivotally connected to the frame such that the torsion bar is movable over a range of travel between a closed position, wherein the sealing member is in occluding relationship with the dispensing ports such that liquid in the liquid storage tank is prevented from being dispensed from the dispensing ports, and an open position, wherein the sealing member is displaced from the dispensing ports such that liquid in the liquid storage tank is allowed to flow from the liquid storage tank through the dispensing ports, the torsion bar biased to the closed position.

8. The blade assembly of claim 7, wherein the valve mechanism includes a trigger mechanism arranged with the torsion bar, the trigger mechanism adapted to selectively move the torsion bar from the closed position to the open position.

9. The blade assembly of claim 1, further comprising:
a moldboard attached to the frame;
a blade attached to the moldboard.

10. The blade assembly of claim 1, wherein the moldboard extends along a transverse axis, and the liquid storage tank includes a plurality of dispensing ports disposed in spaced relationship to each other along the transverse axis.

11. The blade assembly of claim 1, wherein the liquid storage tank includes an interior surface having a corrosion-resistant coating.

12. A machine comprising:
a machine body;
a blade assembly mounted to the machine body, the blade assembly including:
a frame, and
a liquid storage tank integrally arranged with the frame, the liquid storage tank including a fill port and at least one dispensing port.

13. The machine of claim 12, wherein the blade assembly includes an outer perimeter, the liquid storage tank being configured such that the liquid storage tank is disposed within the outer perimeter of the blade assembly.

14. The machine of claim 12, wherein the liquid storage tank includes an upper portion defining the fill port, the fill port adapted to be selectively occluded such that liquid in the liquid storage tank is prevented from being dispensed from the liquid storage tank through the fill port.

15. The machine of claim 12, wherein the blade assembly is pivotally mounted to the machine frame such that the blade assembly is pivotally movable over a range of travel between a raised position and a lowered position, the liquid storage tank configured such that the liquid storage tank is in non-interfering relationship with the machine frame when the blade assembly is moved over the range of travel between the lowered position and the raised position.

16. A method for dispensing liquid at a worksite, the method comprising:
storing liquid in a liquid storage tank integrally formed with a frame of a blade assembly attached to a machine;
moving the machine over the worksite;
dispensing liquid from the liquid storage tank upon a surface of the worksite.

17. The method for dispensing liquid at a worksite according to claim 16, wherein the liquid comprises leachate.

18. The method for dispensing liquid at a worksite according to claim 17, wherein the worksite comprises a landfill.

19. The method for dispensing liquid at a worksite according to claim 16, wherein liquid is stored in the liquid storage tank by filling the liquid storage tank with a liquid poured through a fill port communicating with the interior of the liquid storage tank.

20. The method for dispensing liquid at a worksite according to claim 16, wherein liquid is selectively dispensed from the liquid storage tank upon the surface of the worksite by operating a valve mechanism arranged with at least one dispensing port communicating with the interior of the liquid storage tank.
